(19) United States
(12) Patent Application Publication
(10) Pub. No.: US 2005/0261386 A1
(43) Pub. Date: Nov. 24, 2005

(54) Latex-enhanced polyurethane foam cushioning

(76) Inventors: Bruce H. Schneider, Council Bluffs, IA (US); Robert A. Heller, Council Bluffs, IA (US)

Correspondence Address: Bruce H. Schneider & Robert A. Heller;c/o Future Foam, Inc., 1610 Avenue N, Council Bluffs, IA, 51501, US

(21) Appl. No.: 10/852,365

(22) Filed: May 24, 2004

(51) Int. Cl. C08J 9/00

(52) U.S. Cl. 521/50; 521/155

(57) ABSTRACT

Chemically and thermodynamically amplifying the prior art concept of the heat-producing exothermically-reactive selective polyol and selectable isocyanate chemicals for the conventional production of polyurethane foam-cushioning having a CVR-value fraught with comfort deficiency: The novel amplification herein co-introduces polymerizable latex into the exothermically co-reactable polyol and isocyanate mixture, and which such ancillarily produced exothermic-heat polymerizes the co-introduced latex. The result is economically yielded “latex-enhanced polyurethane foam-cushioning” having a CVR-value not experienced with conventional polyurethane foam-cushioning.

### PRIOR RELATED PATENT APPLICATION FILING

The present patent application finds its genisis in disclosures made in applicant′ prior USA provisional application Ser. No. 60/473,624 (filed 27 May 2003).

### BACKGROUND OF THE INVENTION

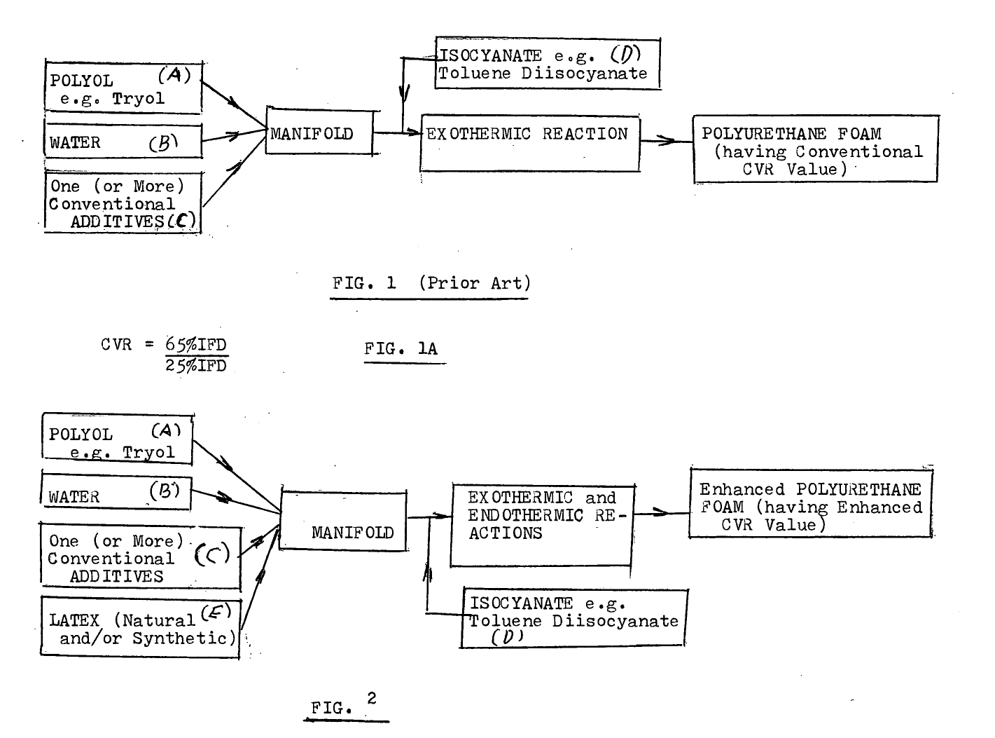

For the industry concerned with the attainment of com fortable cushioning material (utilizable, inter alia, for pillows, mattresses, and within upholstered furniture) two distinct manufacturing processes are currently industrially utilized, namely:
(a) chronologically earliest are those wholly relying upon vulcanized latexes (earlier natural latexes, and later synthetic latexes) and which cushioning materials have a desireably high CVR comfort value. (as alluded to in appended drawing FIG. 1A, such CVR comfort value is defined as the ratio between 65% IFD and 25% IFD ratings for the same cushioning material. the IFD rating being an industry standard described in ASTM-D(3574)). However, utilization of vulcanizable latexes for the attainment of cushioning having desirably high CVR comfort values is fraught with the very high cost of latex raw materials; and
(b) as alluded to in the teachings of U.S. Pat. Nos. 5,120,771 and 5,123,936: the flow diagram of appended drawing FIG. 1 is self-explanatory for the production of polyurethane foam material, convertible thereafter into cushions, mattresses and other cushioning usages. Though cushions produced wholly from polyurethane is relatively economical, they are encumbered with relatively-low CVR values.

### GENERAL OBJECTIVE OF THE PRESENT INVENTION

In view of the foregoing Background of the Invention, it is the General Objective of the present invention to overcome the CVR limitations of wholly polyurethane cushioning materials, but without significant sacrifice to the economics of manufacturing cushioning material.

### GENERAL STATEMENT OF THE INVENTION

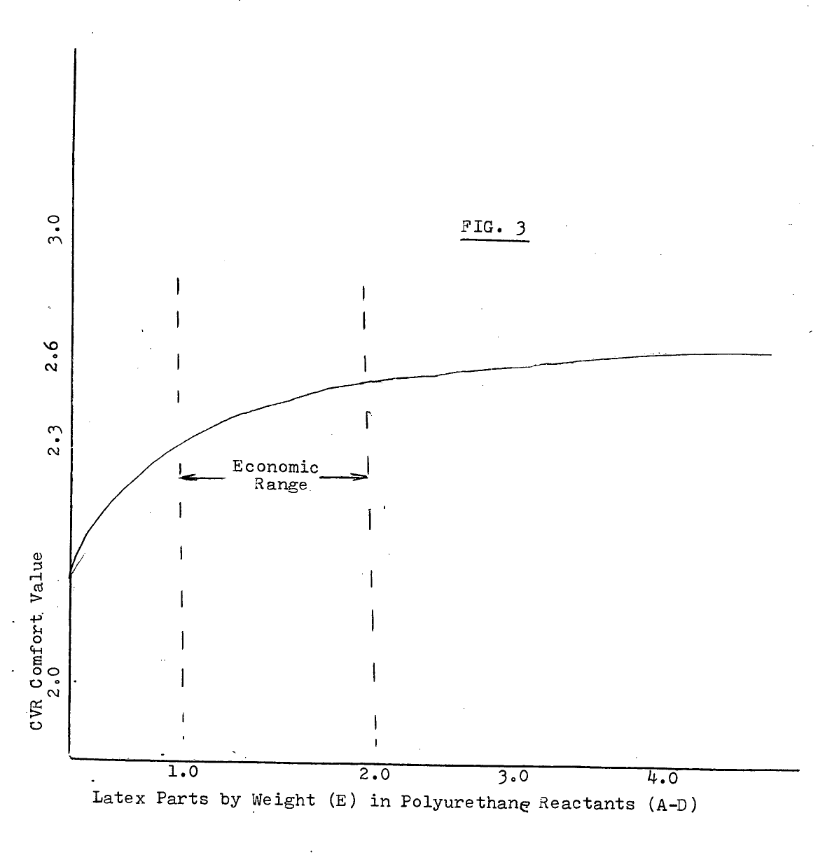

With the above mentioned General Objective in view, and together with other ancillary and related objectives which will become more apparent as this description proceeds: the “Latex-Enhanced Polyurethane Foam Cushioning” of the present invention is predominately manufactured by the traditional polyurethane-foam yielding exothermic chemical reaction between a polyol and an isocyanate, but which cushioning in its manufacture includes therewithin at least 1% by weight natural and/or synthetic latex endothermically vulcanized within said same exothermic polyurethane chemical reaction, to thereby economically produce cushioning material having a relatively high CVR comfort value not heretofore attainable with wholly polyurethane cushioning material. Readily adaptable manufacturing processes for the sought “Latex-Enhanced Polyurethane Foam Cushioning” is alluded to in the appended drawing FIGS. 1 and 2 and within the ensuing Detailed Description of the Drawing.

### BRIEF DESCRIPTION OF THE DRAWING

In the drawing, wherein like characters refer to like parts in the several views, and in which:

Drawing FIG. 1 is a schematic flow diagram alluding to prior art methods for exothermically manufacturing polyurethane foams convertably utilizable for cushioning materials having a testable CVR comfortvalue;

Drawing FIG. 1A mathematically defines under ASTM-D(3574) a testable CVR comfort value for cushioning materials;

Drawing FIG. 2 is a schematic flow diagram heavily alluding to the FIG. 1 prior art, but differing for the further interjection of a vulcanizable latex consistent with the method and product-by-process “Latex-Enhanced Polyurethane Foam Cushioning” of the present invention; and

Drawing FIG. 3 graphically depicts an economic range of interjectionable latex material for attaining an enhanced CVR comfort value for cushioning material manufactured according to the drawing FIG. 2 manufacturing process.

### DETAILED DESCRIPTION OF THE DRAWING

In furtherance to the aforedescribed brief mention of prior art drawing FIG. 1, a more detailed description thereof now ensues to serve as an analagous precursor to the inventive subject matter of drawing FIG. 2. As mentioned in the schematic processing steps and resultant product-by-process flow diagram of drawing FIG. 1: the prior arts teach charging into a Manifold of a selectable Polyol (A), water (B) and one or more selectable Additives (C), and thereafter followed by agitation within a Mix-Head having freshly introduced therein of a selectable isocyanate (D). Such introduced isocyanate (D) provokes an exothermic chemical reaction among the mileu of incoming components (A)-(C) to yield a Polyurethane Foam (having a conventional CVR comfort value of around 2.0). In the latter regard, the reader's attention is directed to drawing FIGS. 1A and 3. Whether batchwise and/or continuously charged into the Manifold and Mix-Head steps, the gravimetric ratio for the Polyol (A) e.g. tryol and the Isocyanate (D) e.g. toluene diisocyanate, of about “two-to-three”, so as to yield a such Polyurethane Foam. However, such ratio of “about three” can be varied somewhat according to prior art empiracal technological know-how, depending upon desired attrinon-CVR physical attributes for the yielded Polyurethahe Foam.

Departing now from the heretofore described prior art and flow sheet diagram enunciated with reference to drawing FIG. 1: in the en suing specific Detailed Description of the Drawing and which at flow diagram FIG. 2 predominately announces the rendition into the ultimately yielded Polyurehane Foam of a natural and/or synthetic polymerizable Latex (E) that bears a geometric ratio of about 1% as compared to the stoichiometric products of the heat-generated exothermically reacting tryol (A) and the isocyanate (D) within an agitated Mix-Head. Simultaneously, the heat from the exothermic reaction (A) and (D) endthermically vulcanizes the ancillarily introduced Latex (E) into the desired about 1% gravimetric ratio within resultant novel Enhanced Polyurethane Foam (having enhanced CVR value). As alluded to in drawing FIG. 3, the “economic range” for the gravimetric ratio of the relatively expensive Latex (E) need not exceed 2% (much above 1% being not justified from the economic standpoint).

As a representative (but not limiting) example of the drawing FIGS. 2 and 3 teachings alluded to in the immediately preceeding paragraph, the following batchwise and/or continuously-charged recipe for the aforementioned ingredients might be typically employed in the gravimetric sense:
100 parts Polyol (A) e.g. in the form of tryol;
   4.2 parts water (B);
   1.9 parts Additives (C) e.g. surfactant+tertiary amine+organic metal catalyst, etc.
   33.0 parts Isocyanate (D) e.g. toluene diisocyanate; and
   1.4 parts Selectable natural and/or synthetic Latex (E).
      Again, as mentioned in the second immediately preceeding paragraph, prior art technologies might allow slight variations to elements (A)-(D) in consistency with the teachings of attached drawing FIGS. 2 and 3.

From the foregoing, the processing steps and resultant product-by-process for the “Latex-enhanced Polyurethane Foams” of the present invention will be readily understood by workers in this art, and accordingly, a range of equivalents are asserted in the ensuing presentations of claimed subject matter.

1. “Latex-Enhanced Polyurethane ‘Foam Cusioning’” predominately manufactured by the traditional polyurethane-foam yielding exothermic chemical reaction between some selected polyol and some selected member of the isocyanate family, and which resultant ‘foam cushioning’ further includes therewithin at least some gravimetric value flanking one-part by weight of latex material having been introduced alongside said chemical reaction endothermically to thereby produce economic consistent ‘foam cushioning’ having a CVR comfort value not heretofore attainable from wholly polyurethane-foam derived cushioning material.

2. The manufacturing process of claim L and which further entails charging ultimately into a factory mix-head chamber of: a polyol, an isocyanate family member, water, one (or more) conventional additives, and an endothermicaly vulcanizable latex material, to thereby co-reactably yield ‘Foam Cushioning’ having a CVR comfort value exceeding about 2.30 and up to about 2.60.

3. The process of claim 2 wherein the endothermically vulcenizable latex takes the form of natural latex.

4. The process of claim 2 wherein the endothermically vulcenizable latex takes the form of a synthetic latex.

5. The process of claim 4 wherein the synthetic latex takes the form of styrene butadiene rubber.

6. The process of claim 2 wherein the diisocyanate is selected from the isocyanate family, including inter alia, toluene diisocynate.

7. The ‘foam cushioning’ product yielded by the process set forth in claim 2.

8. The ‘foam cushioning’ product yielded by the process set forth in claim 6.

9. The product-by-process resulting from the method steps recited in claim 1 and wherein the latex material bears a gravimetric ratio of about 1% as compared to the exothermic gravimetric exothermic result between the selected polyol and selected socyanate.
